(19) United States
(12) Patent Application Publication
(10) Pub. No.: US 2002/0152052 A1
(43) Pub. Date: Oct. 17, 2002

(54) Electronic apparatus for detecting an abnormal state, a method for detecting the abnormal state, a system of the electronic apparatus for detecting the abnormal state, a computer program for detecting the abnormal state and a computer-readable storage medium for recording the computer program for detecting the abnormal state

(76) Inventor: Kaoru Tsuru, Tokyo (JP)

Correspondence Address: BIRCH STEWART KOLASCH & BIRCH, PO BOX 747, FALLS CHURCH, VA, 22040-0747, US

(21) Appl. No.: 10/107,340

(22) Filed: Mar. 28, 2002

(30) Foreign Application Priority Data
Apr. 13, 2001 (JP) 2001-115423

(51) Int. Cl. G06F 11/30; G06F 15/00; G21C 17/00

(52) U.S. Cl. 702/183

(57) ABSTRACT

Among computers which are monitored mutually, originating from an arbitrary computer, the state is inquired sequentially according to a ring sequence list, and state information is updated in every inquiry. Accordingly, the state information is shared among all the computers.

### BACKGROUND OF THE INVENTION

1. Field of the Invention

This invention relates to detection of an abnormal state in an electronic apparatus.

2. Description of the related Art

FIG. 12 shows a configuration for detecting the abnormal state in a computer connected to a network by using a monitoring computer in accordance with SNMP (Simple Network Management Protocol) according to the related art. SNMP is a standard protocol for sending network management information of a network apparatus to a management system. In the related art, in accordance with this standard protocol, a SNMP manager (1) provided in the monitoring computer (2) periodically inquired state information (a) of SNMP agents (3) provided in monitored computers #I (4)-#N (5) by a request of a user, and the inquired SNMP agents (3) responded (b). When there was no response for a determined time, the inquired computer was judged to be in an abnormal state, and state information (6) was updated (c).

### SUMMARY OF THE INVENTION

In the related art, there was only one computer which monitored the monitored computers, and it was impossible to share the state information among the computers. Further, when the monitoring computer became in an abnormal state, it was even impossible to monitor.

It is one of objects of this invention to detect an abnormal state in a monitored electronic apparatus by an electronic apparatus.

According to an aspect of this invention, an electronic apparatus for detecting an abnormal state includes a recording unit for recording monitored object identification information for identifying a monitored electronic apparatus which is one of a plurality of electronic apparatuses for detecting the abnormal state and state information, a state inquiring unit for sending the state information recorded by the recording unit to the monitored electronic apparatus identified based on the monitored object identification information recorded by the recording unit, inquiring state information of the monitored electronic apparatus to detect an abnormal state in the monitored electronic apparatus, receiving a response from the monitored electronic apparatus, and updating the state information recorded in the recording unit based on the response received, and a state responding unit for receiving the state information of the monitored electronic apparatus sent by the monitored electronic apparatus, responding the state information recorded in the recording unit to an inquiry about the state information from the monitored electronic apparatus, and recording the state information of the monitored electronic apparatus received in the recording unit.

According to another aspect of this invention, a method for detecting an abnormal state includes recording monitored object identification information for identifying a monitored electronic apparatus which is one of a plurality of electronic apparatuses for detecting the abnormal state and state information, sending the state information recorded to the monitored electronic apparatus identified based on the monitored object identification information recorded, inquiring state information of the monitored electronic apparatus to detect an abnormal state in the monitored electronic apparatus, receiving a response from the monitored electronic apparatus, and updating the state information based on the response received, and receiving the state information of the monitored electronic apparatus sent by the monitored electronic apparatus, responding the state information recorded to an inquiry about the state information from the monitored electronic apparatus, and recording the state information of the monitored electronic apparatus received.

According to another aspect of this invention, a computer program for detecting an abnormal state includes a code segment for recording monitored object identification information for identifying a monitored electronic apparatus which is one of a plurality of electronic apparatuses for detecting the abnormal state and state information, a code segment for sending the state information recorded to the monitored electronic apparatus identified based on the monitored object identification information recorded, inquiring state information of the monitored electronic apparatus to detect an abnormal state in the monitored electronic apparatus, receiving a response from the monitored electronic apparatus, and updating the state information based on the response received, and a code segment for receiving the state information of the monitored electronic apparatus sent by the monitored electronic apparatus, responding the state information recorded to an inquiry about the state information from the monitored electronic apparatus, and recording the state information of the monitored electronic apparatus received.

According to another aspect of this invention, a computer-readable storage medium has a computer program for detecting an abnormal state recorded thereon, and the computer program includes a code segment for recording monitored object identification information for identifying a monitored electronic apparatus which is one of a plurality of electronic apparatuses for detecting the abnormal state and state information, a code segment for sending the state information recorded to the monitored electronic apparatus identified based on the monitored object identification information recorded, inquiring state information of the monitored electronic apparatus to detect an abnormal state in the monitored electronic apparatus, and receiving a response from the monitored electronic apparatus, and updating the state information based on the response received, and a code segment for receiving the state information of the monitored electronic apparatus sent by the monitored electronic apparatus, responding the state information recorded to an inquiry about the state information from the monitored electronic apparatus, and recording the state information of the monitored electronic apparatus received.

According to another aspect of this invention, a system for detecting an abnormal state includes a plurality of electronic apparatuses for detecting the abnormal state, and each of the plurality of electronic apparatuses includes a recording unit, a state inquiring unit and a state responding unit. The recording unit records monitored object identification information for identifying a monitored electronic apparatus which is one of the plurality of electronic apparatuses for detecting the abnormal state and state information. The state inquiring unit identifies the monitored electronic apparatus based on the monitored object identification information recorded by the recording unit, sends the state information recorded by the recording unit to the monitored electronic apparatus identified, and inquires state information of the monitored electronic apparatus to detect an abnormal state in the monitored electronic apparatus, and a state responding unit of the monitored electronic apparatus inquired sends the state information recorded in a recording unit of the monitored electronic apparatus to the state inquiring unit which has inquired, and records the state information received in the recording unit of the monitored electronic apparatus. The state inquiring unit inquired further receives the state information of the monitored electronic apparatus sent by the monitored electronic apparatus, and records the state information received in the recording unit of the own electronic apparatus for detecting the abnormal state.

Further features and applications of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

Other objects features, and advantages of the invention will be apparent from the following description when taken in conjunction with the accompany drawings.

### BRIEF DESCRIPTION OF THE DRAWINGS

FIG. 1 shows a block chart in Embodiment. 1 of this invention;

FIG. 2 illustrates a data structure of a ring sequence list in Embodiments 1-7 of this invention;

FIG. 3 illustrates a data structure of state information in Embodiments 1-7 of this invention;

FIG. 4 shows a block chart of a processing by a state inquiring unit in Embodiment 1 of this invention;

FIG. 5 shows a block chart of a processing by a state responding unit in Embodiment 1 of this invention;

FIG. 6 shows a block chart in Embodiment 2 of this invention;

FIG. 7 shows a block chart in Embodiment 3 of this invention;

FIG. 8 shows a block chart in Embodiment 4 of this invention;

FIG. 9 shows a block chart in Embodiment 5 of this invention;

FIG. 10 shows a block chart in Embodiment 6 of this invention;

FIG. 11 shows a block chart in Embodiment 7 of this invention; and

FIG. 12 shows a block chart of a configuration according to the related art.

### DETAILED DESCRIPTION OF THE PREFERRED EMBODIMENTS

### Embodiment 1

An embodiment of this invention is explained.

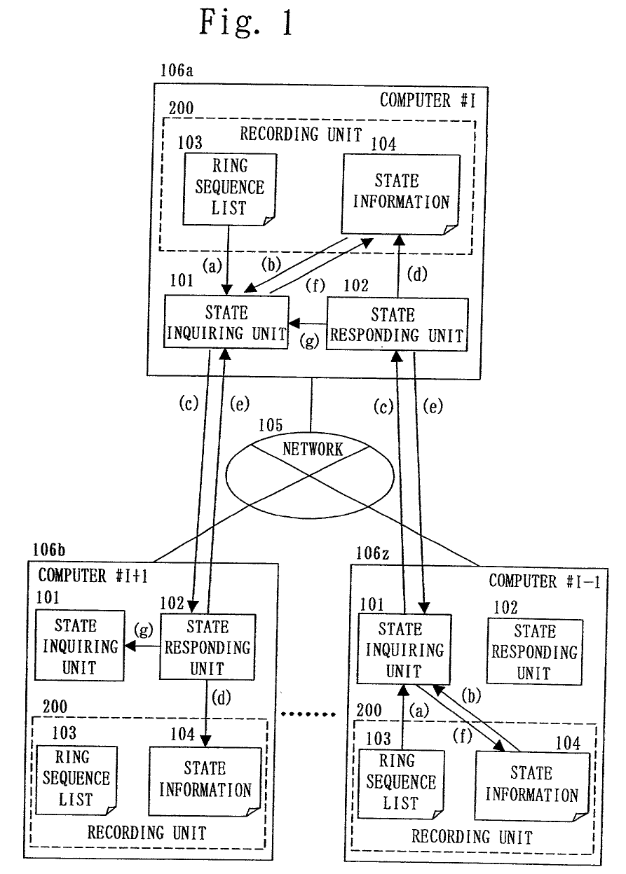

FIG. 1 illustrates a basic configuration of this embodiment. In FIG. 1, computers are provided as electronic apparatuses. In FIG. 1, each of computers 106a-106z (hereinafter, called as computers 106) includes a state inquiring unit 101, a state responding unit 102, and a recording unit 200.

Among the units, the state inquiring unit 101 has a function for inquiring an operation state in the computer 106 which is an object to be monitored. The state responding unit 102 has a function for responding to an inquiry about the operation state. The recording unit 200 has a function for recording monitored object identification information (a ring sequence list 103 in FIG. 1) and state information 104. The monitored object identification information includes identification information on the monitored computer 106 which is one or more than one for identifying the monitored computer 106. For example, in FIG. 1, the computer 106b is identified as the computer has been monitored by the computer 106a based on the monitored object identification information.

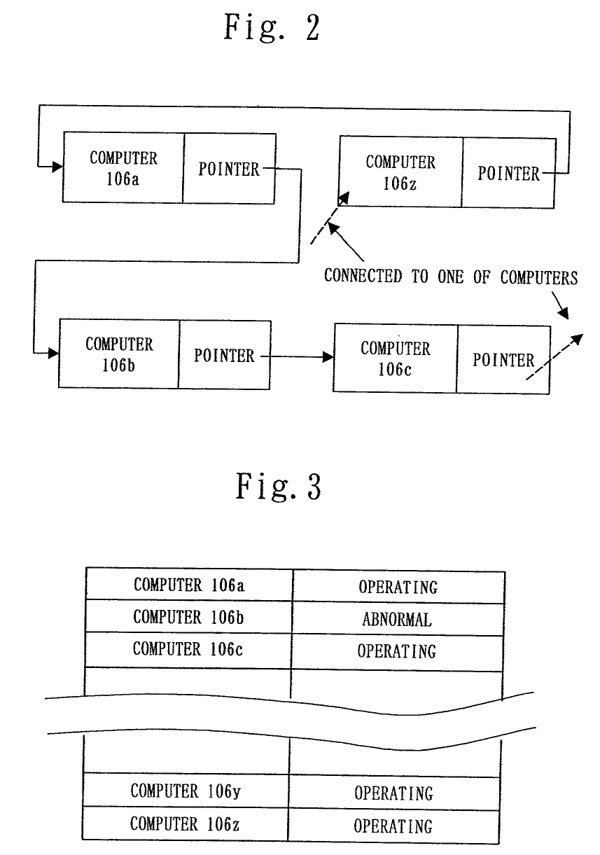

A data structure of the monitored object identification information can be a list structure as illustrated in FIG. 2, for example. The list structure is a structure in which the computers 106 (106a, 106b . . . ) are connected by a pointer (which maintains an address of data to be accessed in the next). One of the computers connected by the pointer functions as a computer for detecting the abnormal state, and the other computer connected by the pointer functions as a monitored computer. Therefore, when a structure is a list structure as illustrated in FIG. 2 where the pointer connects the computer 106z which is recorded in the list last to the computer 106a which is recorded in the list first, the list is the ring sequence list. In the embodiment illustrated in FIG. 1, the monitored object identification information is recorded in a structure of the ring sequence list. In FIG. 2, the pointer in the list identifies one monitored computer. However, it is also possible to identify two or more computers. It is also possible that the pointer of the monitored computer includes identification information of the computer which detects the abnormal state. Further, it is also possible that the pointer in the list is a two-way pointer which points at both the monitored computer located before the own computer and the monitored computer located after the own computer.

The state information 104 recorded by the recording unit 200 includes information showing if each of all the computers 106 connected to a network 105 is operating. A structure of the state information 104 can be a table structure as illustrated in FIG. 3 where each of the computers 106a, 106b . . . and an operation state in each of the computers are corresponded. In FIG. 3, the operation state in each of the computers is recorded. It is also possible that the table maintains information on a time when each of the computers checked the operation state.

The network 105 is a network in which the computers are mutually connected. The network can be either a wired network or a wireless network. The network can be any mechanism for sending information to the electronic apparatus including the computer and receiving information from the electronic apparatus including the computer.

Operations of the computers 106 illustrated in (a)-(g) of FIG. 1 are explained. In FIG. 1, it is assumed that the computer 106a is a computer #I for detecting the abnormal state. The computer 106b is a computer #I+1 which is identified as a computer to be monitored by the computer 106a according to the ring sequence list 103 in the recording unit 200 of the computer 106a, and the computer 106b is located immediately after the computer 106a (#I). The computer 106z is a computer #I−1 which monitors the computer 106a according to the ring sequence list 103 in the recording unit 200 of the computer 106z, and the computer 106z is located before the computer 106a (#I).

The state inquiring unit 101 of the computer 106a at an origin reads the ring sequence list 103 recorded by the own recording unit 200, and identifies the monitored computer 106b in the ring sequence list (a). Then, the state inquiring unit 101 reads the own state information 104 recorded by the recording unit 200 (b). Then, the state inquiring unit 101 sends the read state information 104 to the state responding unit 102 of the identified monitored computer 106b, and inquires the state in the monitored computer 106b (c). Then, the state responding unit 102 of the monitored computer 106b which is inquired of stores the received state information 104 and a present state in the own computer in the state information 104 of the own computer (d), and sends the state information 104 recorded in the own recording unit 200 as a response to the computer 106a which inquired (e). The state inquiry unit 101 of the computer 106a which has received the response judges that the monitored computer 106b is in a normal state, and updates the own state information 104 (f).

Meanwhile, the state responding unit 102 of the computer 106b judges that an inquiry is ended, and notifies the own state inquiry unit 101 that the inquiry is ended (g).

When the state inquiring unit 101 of the computer 106b notified in the above (g) inquires of a monitored computer (computer 106c in FIG. 2) which is an object to be monitored by the computer 106b as the state inquiry unit 101 of the computer 106a does, and performs processings (a)-(g) for detecting the abnormal state, processings are performed one after another; the computer 106a performs a processing for detecting an abnormal state in the computer 106b, then the computer 106b performs a processing for detecting an abnormal state in the computer 106c, . . . . Therefore, when the monitored object identification information has a structure of the ring sequence list 103 as illustrated in FIG. 2 and the state information 104 maintains operation states of all the computers 106 as illustrated in FIG. 3, a state in each of the monitored computers in a ring is inquired sequentially. If the monitored computer is operating normally, the state information 104 of the monitored computer is updated sequentially. Therefore, when the computer 106z performs a processing for detecting the abnormal state in the computer 106a in FIG. 2, the state information 104 of the computer 106a is updated. In this way, the state information 104 of each of all the computers 106 connected in the ring sequence list 103 is updated sequentially. Consequently, the state information 104 can be shared among all the computers 106.

As stated, since the processing (for starting detection of the abnormal state) is triggered by receiving an inquiry at one or more computers 106 maintaining the state information 104, the state information 104 can be shared among all the computers 106. Therefore, a configuration without using the monitoring computer which was necessary in the related art can be realized. Further, since it is not necessary to exchange data with the monitoring computer, a processing speed for detecting the abnormal state becomes much faster than a processing speed in a configuration according to the related art, in which the monitoring computer is necessary. Further, a load can be distributed, and a performance of a respective computer which has become higher in recent years can be utilized effectively. Further, a problem that when the monitoring computer is in the abnormal state, monitoring becomes impossible can be solved. Hence, a reliability can be improved.

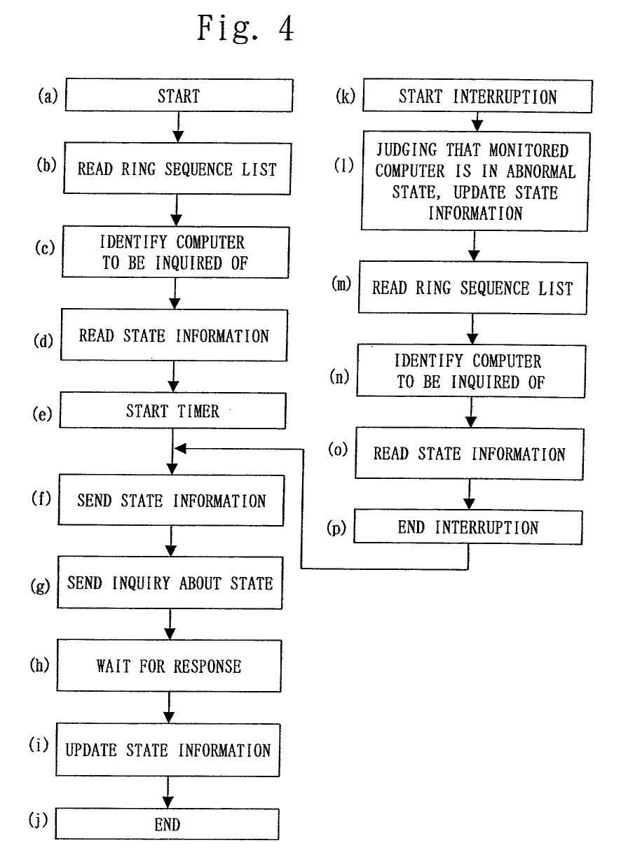

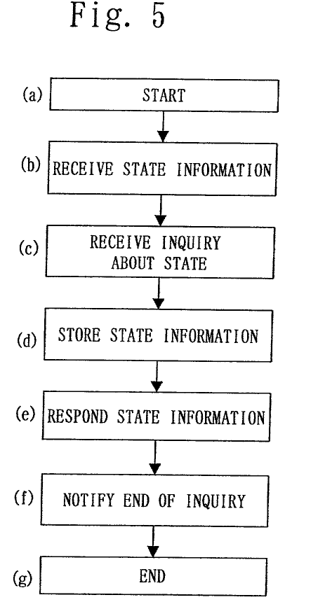

FIG. 4 illustrates an embodiment of the state inquiring unit 101.

FIG. 4 shows a flow chart of the state inquiring unit 101 when the computer 106 identified in the ring sequence list 103 at first is in the abnormal state, and the computer 106 identified in the next is operating normally.

The state inquiring unit 101 is started arbitrarily or by being notified by the state responding unit 102 that the processing is ended (a). Then, the state inquiring unit 101 reads the ring sequence list 103 recorded by the own recording unit 200 (b), and identifies the monitored computer 106 to be inquired of in the ring sequence list 103 (c). Then, the state inquiring unit 101 reads the state information 104 recorded in the own recording unit 200 (d).

Then, the state inquiring unit 101 starts a timer in which a response time of the monitored computer 106 is set (e), and sends the state information 104 to the monitored computer 106 (f). Then, the state inquiring unit 101 sends an inquiry about the operation state to the monitored computer 106 (g), and waits for a response from the monitored computer 106 (h).

Since the computer 106 which is identified at first is in the abnormal state, the state inquiring unit 101 does not receive the response from the monitored computer 106 within the time set in the timer. Hence, a timer interruption occurs (k). Therefore, the state inquiring unit 101 judges that the monitored computer 106 is in the abnormal state, and updates the own state information 104 (l). Then, the state inquiring unit 101 reads the ring sequence list 103 (m), and identifies a next monitored computer 106 to be inquired of (n). Then, the state inquiring unit 101 reads the state information 104 recorded in the own recording unit 200 (o), and ends the interruption (p).

When the interruption is ended, the state inquiring unit 101 goes back to the processing for sending the state information 104 to the next monitored computer (f), sends an inquiry about the operation state to the next monitored computer 106 (g), and waits for the response from the next monitored computer 106 (h).

Since the next monitored computer 106 is operating normally, the state inquiring unit 101 receives the response from the next monitored computer 106, updates the state information 104 in the own recording unit 200 (i), and ends the processing (j).

FIG. 5 illustrates an embodiment of the state responding unit 102.

FIG. 5 shows a flow chart of the processing by the state responding unit 102 when the own computer 106 is operating normally.

The state responding unit 102 is started by an inquiry from the state inquiring unit 101 which originates the inquiry (a). The state responding unit 102 receives the state information 104 sent by the state inquiring unit 101 (b), receives the inquiry about the operation state (c), and stores the received state information and a present state in the own computer in the own state information 104 (d). Then, the state responding unit 102 sends the state information 104 to the state inquiring unit 101 which originated the inquiry (e), notifies the own state inquiring unit 101 that the inquiry is ended, (f), and ends the processing (g).

In the processing for detecting the abnormal state in the above-stated embodiment, a plurality of computers 106 connected to a wide area network, e.g., Internet, etc. maintains the state information 104 of each of the computers monitored mutually. Further, the plurality of computers 106 includes the state inquiring unit 101 for sending the state information 104 maintained in the own computer to an arbitrary computer and inquires the state, the state responding unit 102 for updating the state information 104 and responding when the inquiry about the state is received, and the ring sequence list 103 of the computers arbitrarily combined. The state inquiring unit 101 inquires the state in the monitored computer in the ring sequence list 103. The state responding unit 102 of the inquired monitored computer updates the state in the own computer in the received state information, and responds to the inquiring computer. In this way, the processing is continued by the state inquiring unit 101, and the state information 104 of all the computers 106 in the ring sequence list 103 is updated sequentially.

As stated, in Embodiment 1, when there is no response from a computer within a determined time set in the timer, the state inquiring unit 101 judges that the computer is in the abnormal state, and this state information 104 can be shared among all the computers 106.

### Embodiment 2

With reference to FIG. 1, an embodiment when a plurality of computers are in the abnormal state is explained.

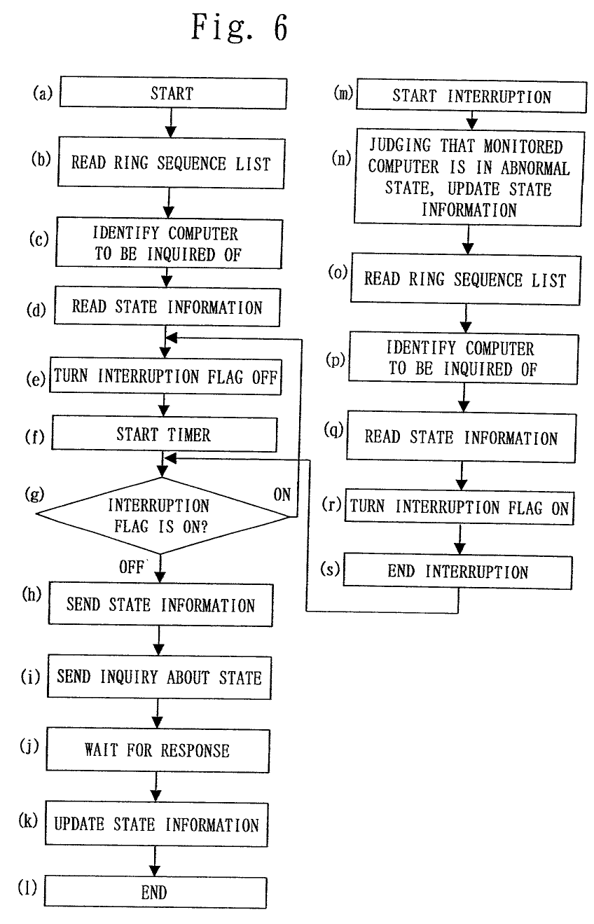

FIG. 6 shows a flow chart of the state inquiring unit 101 according to this embodiment. An interruption flag is written in the flow chart as, when the flow chart is processed in a program and a timer interruption processing provided in the system is performed by starting the timer, the interruption flag is necessary for the timer interruption processing.

The state inquiring unit 101 is started arbitrarily or by being notified by the state responding unit 102 that the processing is ended (a). Then, the state inquiring unit 101 reads the ring sequence list 103 recorded by the own recording unit 200 (b), and identifies the monitored computer 106 to be inquired of in the ring sequence list 103 (c). Then, the state inquiring unit 101 reads the state information 104 recorded in the own recording unit 200 (d).

Then, the interruption flag is turned OFF (e), and the timer, in which the response time of the monitored computer 106 is set, is started (f). Then, a judgement is made if the interruption flag is ON or OFF (g).

When the interruption flag is ON, the processing goes back to the processing for turning the interruption flag OFF (e). Then, the timer is started again (f).

When the interruption flag is OFF, the state inquiring unit 101 sends the state information 104 to the monitored computer 106 (h), sends an inquiry about the operation state in the monitored computer (i), and waits for a response from the monitored computer 106 (j).

When the response is not received from the monitored computer 106 within the time set in the timer, the timer interruption occurs (m). The state inquiring unit 101 judges that the monitored computer 106 is in the abnormal state, and updates the own state information 104 (n). Then, the state inquiring unit 101 reads the ring sequence list 103 (o), identifies a next monitored computer 106 to be inquired of (p), and reads the state information 104 recorded in the own recording unit 200 (q). Then, the interruption flag is turned ON (r), and the interruption is ended (s). Then, the processing goes back to a processing for judging the interruption flag (g).

When the response is received from the monitored computer 106 within the time set in the timer, the state information 104 in the own recording unit 200 is updated (k), and the processing is ended (l).

As stated, the state inquiring unit 101 inquires the state in the monitored computer in the ring sequence list 103, and if there is no response for the determined time, the inquired computer is judged to be in the abnormal state. Then, the state information 104 of the inquired computer is updated, and it is stored that the computer is in the abnormal state. It is also possible to update information on an operation state of the inquired (monitored) computer in the state information 104. Then, the state inquiring unit 101 sends the state information 104 maintained by the own computer to the next monitored computer identified in the ring sequence list 103 and inquires the state. In this way, the state information 104 of all the computers 106 in the ring sequence list 103 is updated.

As stated, when the monitored computer 106 is judged to be in the abnormal state, the next monitored computer is inquired of sequentially. Accordingly, even if a plurality of computers are in the abnormal state, the state information 104 can be shared among all the computers 106.

### Embodiment 3

With reference to FIG. 1, an embodiment of checking the state information 104 and skipping the computer 106 which has been already judged to be in the abnormal state.

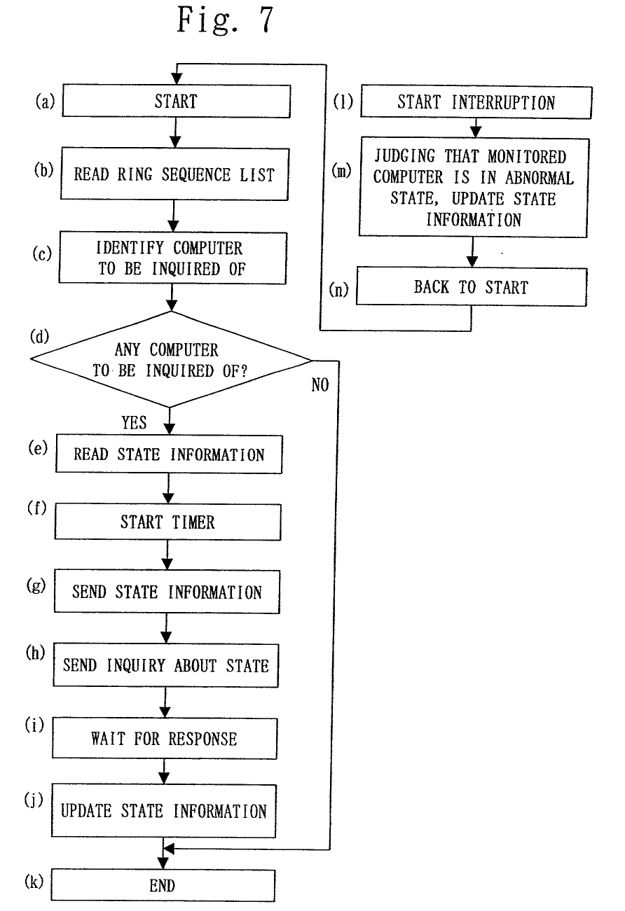

FIG. 7 shows a flow chart of the state inquiring unit 101 according to this embodiment.

The state inquiring unit 101 is started arbitrarily or by being notified by the state responding unit 102 that the processing is ended (a). Then, the state inquiring unit 101 reads the ring sequence list 103 recorded by the own recording unit 200 (b), and identifies the monitored computer 106 which is not inquired of and is in the normal state in the ring sequence list 103 (c). Then, the state inquiring unit 101 checks if there is a monitored computer 106 (d).

When there is no monitored computer 106 (i.e., it is impossible to inquire of any computer except the own computer), the processing is ended (k).

When there is a monitored computer 106, the state information 104 recorded in the own recording unit 200 is read (e), and the timer in which the response time from the monitored computer 106 is set is started (f). Then, the state inquiring unit 101 sends the state information 104 to the monitored computer 106 (g), and sends an inquiry about the operation state in the monitored computer (h). Then, the state inquiring unit 101 waits for the response from the monitored computer 106 (i).

When there is no response from the monitored computer 106 within the time set in the timer, the timer interruption occurs (l). The state inquiring unit 101 judges that the monitored computer 106 is in the abnormal state, and updates the own state information 104 (m). Then, the processing goes back to a start point (n).

When the response is received from the monitored computer 106 within the time set in the timer, the state information 104 in the own recording unit is updated (j), and the processing is ended (k).

The state information 104 of the computer inquired of is checked in the ring sequence list 103, and if the concerning computer is in the abnormal state, the concerning computer is not inquired of Then, a computer which is in the normal state is searched sequentially in the ring sequence list 103, and a computer to be inquired of is identified.

As stated, since the computer 106 which has been already judged to be in the abnormal state is not inquired of, when there is the computer 106 which is in the abnormal state, a queuing time becomes unnecessary. As a result, the processing can be performed in a high speed.

### Embodiment 4

An embodiment of restoring a computer which has been judged to be in the abnormal state is explained.

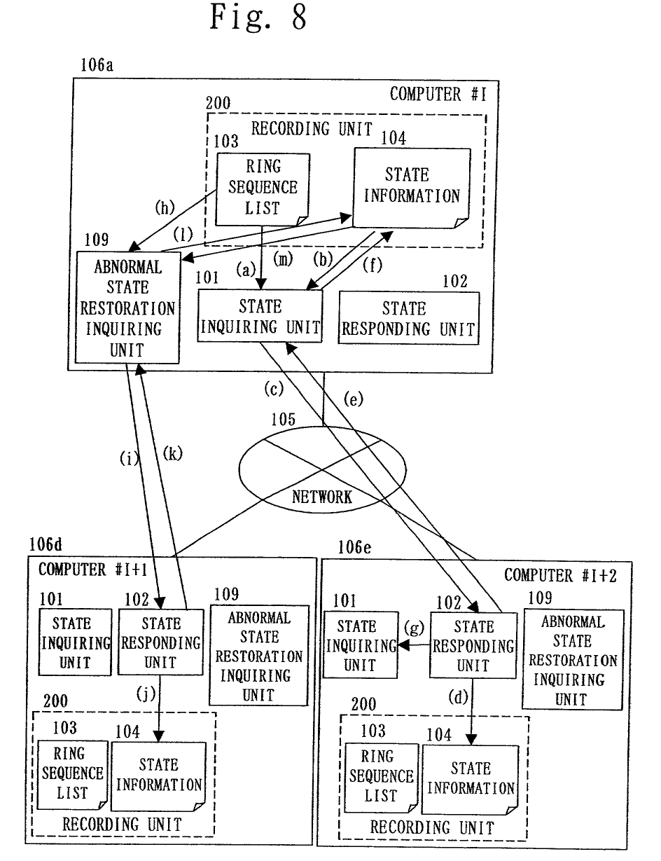

FIG. 8 illustrates a configuration of this embodiment.

The computers 106 include the state inquiring units 101, the state responding units 102, the recording unit 200 and abnormal state restoration inquiring units 109.

A computer 106d is a computer #I+1 which is judged to be in the abnormal state based on the state information 104, and the computer #I+1 is a computer located immediately after the computer #I. A computer 106e is a computer #1+2 which judged to be in the normal state based on the state information 104, and the computer #I+2 is a computer located immediately after the computer 106d (#I+1). Other configurations are same as in FIG. 1.

Operations (a)-(k) in FIG. 8 are explained.

Operations (a)-(g) are same as in Embodiment 1.

In operations (h)-(m), the state inquiring unit 101 of the computer 106a is started, and the abnormal state restoration inquiring unit 109 is started. Then, the own ring sequence list 103 is read (h). A computer (computer 106d in FIG. 8) which is judged to be in the abnormal state located immediately after the own computer is selected as a computer to be inquired of, and the own state information 104 is read (m).

Then, the state inquiring unit 101 sends the state information 104 to the state responding unit 102 of the computer 106d, and inquires the operation state (i). When the computer 106d which is inquired of has been restored, the state responding unit 102 which is inquired of stores the received state information and the present state in the own computer in the own state information 104 (j), and responds to the computer 106a which originated the inquiry (k). The abnormal state restoration inquiring unit 109 which has received the response updates the own state information 104 and stores the information that the computer 106d is in the normal state (l).

As stated, the abnormal state restoration inquiring unit 109 for inquiring if a computer in an abnormal state has been restored is provided. A computer which is not in the abnormal state in the ring sequence list 103 is inquired of by the state inquiring unit 101, and a computer which is in the abnormal state is inquired of by the abnormal state restoration inquiring unit 109. When the inquired computer can respond, the state responding unit 102 responds. The abnormal state restoration inquiring unit 109 which has received the response from the state responding unit 102 updates the state information 104 and stores that the concerning computer is in the normal state.

As stated, in this embodiment, while a regular processing for inquiring is performed, the restoration of the computer which has been judged to be in the abnormal state can be checked in parallel. If the computer has been restored, it is possible to store in the state information 104 that the monitored computer is operating.

### Embodiment 5

In Embodiment 1, when the inquired computer is in the abnormal state, it is necessary to wait till a response time, and it takes time to equalize (update the state information and store the newest information) the state information 104 of each of the computers. Therefore, for shortening the time for equalizing the state information 104, an embodiment of inquiring of two computers in advance is explained.

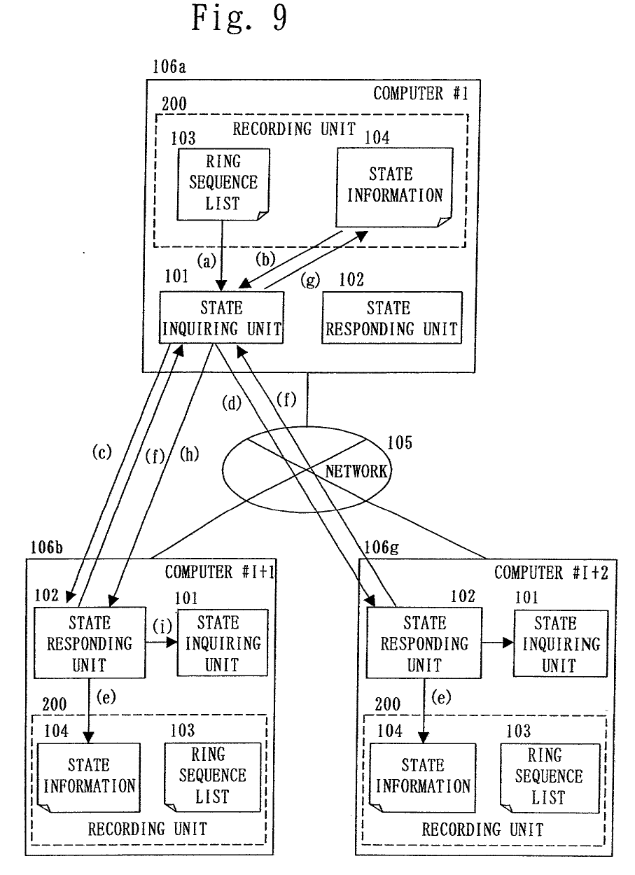

FIG. 9 shows a configuration according to this embodiment. A computer 106g is a computer #I+2 located in the second position after the computer 106a (#I) in the ring sequence list 103. Other elements are same as FIG. 1.

As stated, for inquiring of two computers in advance, the computer (the computer 106a in FIG. 9) for detecting the abnormal state uses two pointers and identifies the monitored computers (the computers 106b and 106g in FIG. 9) in the ring sequence list 103.

Operations (a)-(i) are explained.

The state inquiring unit 101 of the computer 106a at the origin of the inquiry reads the own ring sequence list 103, and identifies the monitored computer 106b in the ring sequence list 103 (a). Then, the state inquiring unit 101 reads the state information 104 (b). The state inquiring unit 101 sends the state information 104 to the state responding unit 102 of the monitored computer 106b, and inquires the state information of the monitored computer 106b (c). In a same way as stated in the above, the computer 106g is also identified as a computer to be inquired of by the state inquiring unit 101. Through a same processing as stated in the above, The state inquiring unit 101 sends the state information 104 also to the state responding unit 102 of the monitored computer 106g, and inquires the state (d).

The state responding unit 102 of the monitored computer 106b and the state responding unit 102 of the monitored computer 106g which are inquired of store the received state information 104 and the present state in the own computer in each of the own state information 104 (e), and respond to the computer 106a which originated the inquiry (f). It is assumed that the computer 106b sent a response earlier than the computer 106g.

The state inquiring unit 101 of the computer 106a which has received the response judges that the monitored computer 106b is in the normal state and updates the own state information 104. The state inquiring unit 101 of the computer 106a also judges that the monitored computer 106g is in the normal state and updates the own state information 104 (g).

Further, the state inquiring unit 101 of the computer 106a sends an instruction for starting detection of the abnormal state to the computer 106b which sent the response earlier (h). The state responding unit 102 of the computer 106b which has received the instruction notifies the own state inquiring unit 101 of this (i). The state inquiring unit 101 which has received the notice starts the processing for detecting the abnormal state in a same way as stated in the above.

Meanwhile, the state responding unit 102 of the computer 106g which has not received the instruction for starting the detection of the abnormal state ends the processing.

As stated, the state inquiring unit 101 sends the state information 104 maintained in the own computer to the computer located immediately after the own computer and the computer located in the second position after the own computer and inquires the state.

In the above-stated embodiment, if one or more computer is operating among the inquired computers, the processing for detecting the abnormal state is continued, and it is not necessary to wait till the response time. Therefore, it is possible to shorten the time for equalizing the content of the state information 104 of each of the computers.

### Embodiment 6

In Embodiment 4 illustrated in FIG. 8, the restoration of the computers located only after the own computer in the ring sequence list 103 is checked. However, in this embodiment, the restoration of the computers located also before the own computer in the ring sequence list 103 is checked.

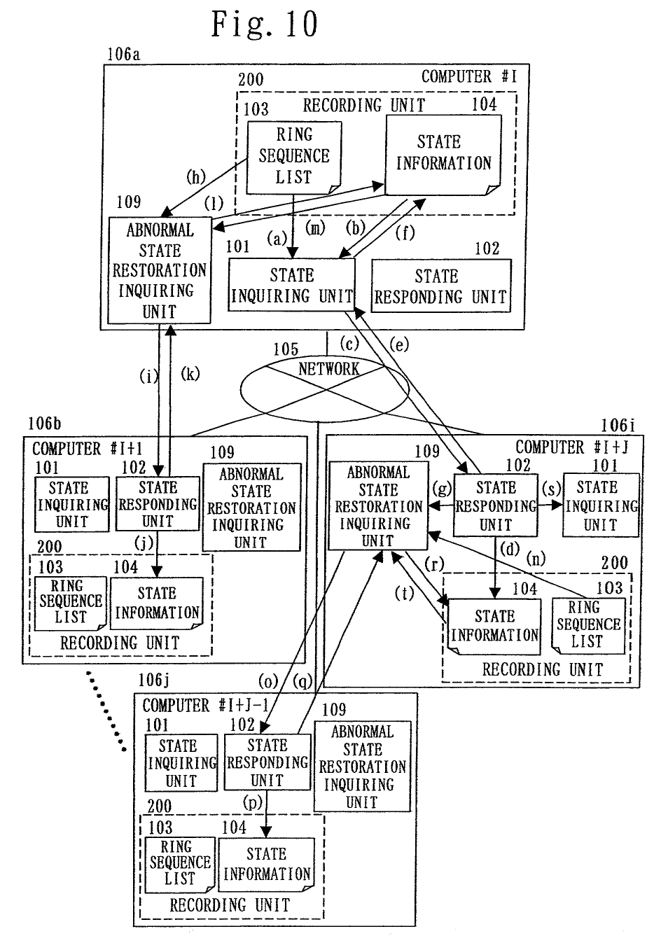

FIG. 10 shows a configuration according to this embodiment.

In FIG. 10, the computer 106b shows the computer #I+1 which is judged to be in the abnormal state, and the computer 106i shows the computer #I+J. Between the computer 106a and the computer 106i, a plurality ((J−1), J≧3) of consecutive computers in the abnormal state is located immediately after the computer 106a. The computer 106j shows the computer #I+J−1 located before the computer 106i (#I+J) in the list. Other elements are same as in FIG. 8.

In this embodiment, the abnormal state restoration inquiring unit 109 of the computer 106a checks the restoration of the computer 106b located after the own computer, and the abnormal state restoration inquiring unit 109 of the computer 106i checks the restoration of the computer 106j located before the own computer. Therefore, in this embodiment, for checking the restoration of the computers both before and after the own computer in the ring sequence list 103, the ring sequence list 103 must have a pointer for pointing at the computer located before the own computer and a pointer for pointing at the computer located after the own computer. In this embodiment, the ring sequence list 103 must include a two-way pointer for pointing at the monitored computers in two directions.

In operations (a)-(t) in FIG. 10, operations (a)-(m) are same as in Embodiment 4.

Operations (n)-(t) are explained.

When the state responding unit 102 of the computer 106i receives the inquiry (c) from the computer 106a, the state responding unit 102 updates the state information 104 of the own computer (d), and responds (e). The state responding unit 102 requests the own abnormal state restoration inquiring unit 109 to start processing for restoring (g), and instructs the own state inquiring unit 101 to start detection of the abnormal state (s).

When the abnormal state restoration inquiring unit 109 is requested to start the processing, the abnormal state restoration inquiring unit 109 reads the ring sequence list 103 of the own computer (n), and reads the state information 104 (t). The abnormal state restoration inquiring unit 109 sends the state information 104 to the computer 106j in the abnormal state which is located before the own computer in the list and inquires of the computer 106j (o). When the inquired computer 106j has been restored, the state responding unit 102 of the inquired computer 106j stores the received state information and the present state in the own computer in the own state information 104 (p), and responds to the computer which originated the inquiry (q). When the computer 106i receives the response, the abnormal state restoration inquiring unit 109 of the computer 106i which has received the response updates the own state information 104 and stores that the concerning computer 106j is in the normal state (r).

As stated, the state responding unit 102 of the inquired computer 106i (#I+J) responds to the computer which originated the inquiry. Further, when the computer located before the own computer is in the abnormal state according to the received state information 104, the abnormal state restoration inquiring unit 109 inquires of the computer 106j (#I+J−1) which is in the abnormal state. If the inquired computer 106j can respond, the state responding unit 102 responds. Then, the abnormal state restoration inquiring unit 109 which has received the response updates the state information 104 and stores that the concerning computer is in the normal state.

The restoration operation of the computer in the abnormal state located before the own computer in the ring sequence list 103 is performed by the abnormal state restoration inquiring unit 109 of the computer 106j like the computer 106i. By performing the restoration operations one after another, when there is a plurality of computers in the abnormal state existing consecutively in the list, it is possible to check the restoration of the computers in a high speed.

A similar restoration operation of the computer in the abnormal state located after the own computer in the ring sequence list 103 can be also performed one after another. It is also possible to perform the restoration operation of the computer in the abnormal state located before the own computer and the computer in the abnormal state located after the own computer in the ring sequence list 103 one after another. In this case, the restoration can be checked in a higher speed.

### Embodiment 7

In Embodiment 1, the inquiry is originated from a computer. In this embodiment, the inquiries are originated from a plurality of computers.

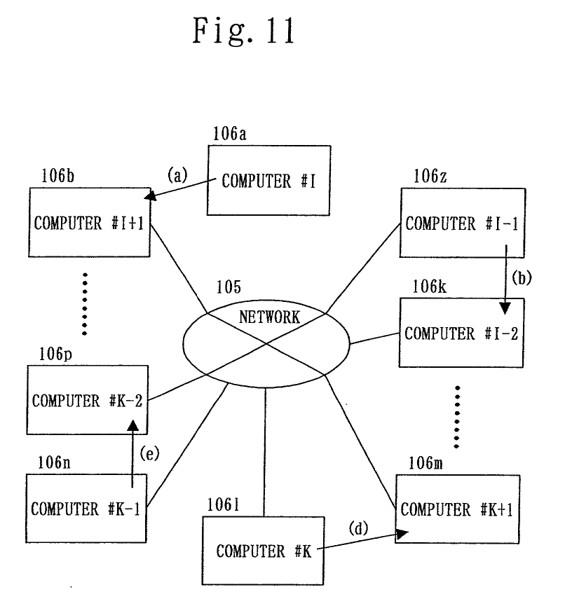

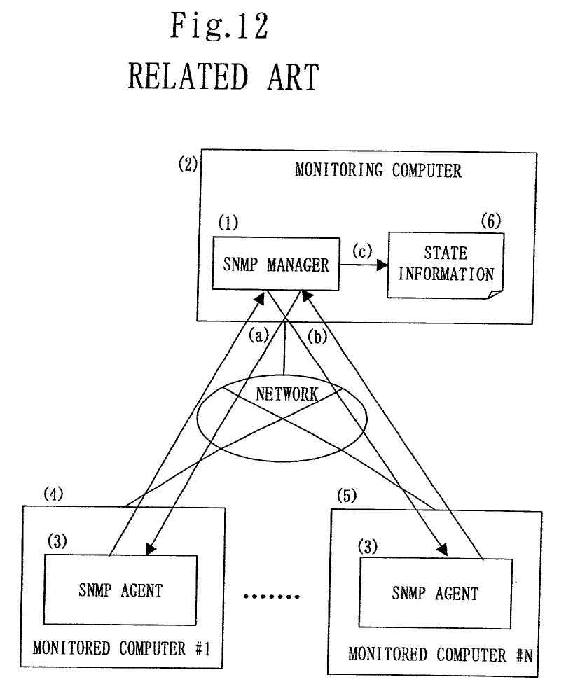

FIG. 11 shows a configuration according to this embodiment.

A computer 106k shows a computer #I−2 located in the second position before the computer 106a (#I) in the ring sequence list 103 of the computer 106a (#I). A computer 106l shows a computer #K which is located in an opposite position of the computer 106a in the ring sequence list 103. A computer 106m shows a computer #K+1 located immediately after the computer #K in the ring sequence list 103 of the computer 106l (#K). A computer 106n shows a computer #K−1 which is located immediately before the computer 106l in the ring sequence list 103 of the computer 106l. A computer 106p shows a computer #K−2 located in the second position before the computer 106l in the ring sequence list 103 of the computer 106l.

Operations are explained.

The processing for inquiring is same as in Embodiment 1. However, in this embodiment, an inquiry of the computer 106b (#I+1) located after the computer 106a (#I), which is originated from the computer 106a (#I) (a), an inquiry of the computer 106k (#I−2) located before the computer 106z (#I−1), which is originated from the computer 106z (#I−1) (b), an inquiry of the computer 106m (#K+1) located after the computer 106l (#K), which is originated from the computer 106l (#K) (d), and an inquiry of the computer 106p (#K−2) located before the computer 106n (#K−1), which is originated from the computer 106n (#K−1) (e) are started simultaneously.

Accordingly, it becomes possible to inquire of four monitored computers simultaneously.

Inquiries about the states of the plurality of monitored computers in the ring sequence list 103 are originated from the plurality of computers sequentially. Therefore, the plurality of inquiries are processed in the plurality of computers. Consequently, an interval for updating the state information recorded in each of the plurality of computers becomes shorter.

When the inquiry about the state is originated from the plurality of computers and especially a number of the computers is large, the processing for updating the state information 104 of each of the computers becomes faster. Therefore, it becomes possible to shorten a time for equalizing a content of the state information 104 of each of the computers 106.

In this embodiment, the plurality of computers 106 which inquire the state can be selected regularly or randomly. It is also possible to divide the computers 106 connected through the network into some groups and select one or more computer 106 in each of the groups. When the computers 106 are divided into some groups, it is possible to conclude the inquiry about the state for detecting the abnormal state within each of the groups. For example, all the computers are divided into four groups. In this case, by detecting the abnormal state one after another within each of the groups, four processing loops are formed as a whole. As a result, an update time of the state information 104 can be reduced to ¼ compared with an update time for processing all the computers one after another in one processing loop. It is needless to say that the update time can be also reduced by processing from four computers one after another in treating all the computers as a processing loop. When the processing is performed one after another and concluded in each of the groups in the above-stated configuration of four groups, the ring sequence list 103 and the state information 104 of each of the computers can include only the computers in the same group. Therefore, an information amount of the ring sequence list 103 and the state information 104 can be reduced to ¼ compared with an information amount of the ring sequence list 103 and the state information 104 without dividing into the groups. However, for sharing the state information 104 among all the computers, the state information 104 must be exchanged among the groups.

As stated, in each of the above embodiments, the operations of the recording unit, state inquiring unit, state responding unit and abnormal state restoration inquiring unit are mutually related. The operation of each of the units can be replaced with a series of operations in considering the relationship of the operations illustrated in each of the embodiments. By replacing in this way, these embodiments are realized as an invention of a method. Further, by replacing the operation of each of the units with a processing for recording, processing for inquiring a state, processing for responding the state, and processing for inquiring abnormal state restoration, these embodiments are realized as embodiments of an invention of a program and embodiments of an invention of a computer-readable medium for recording the program.

Further, in the embodiments of the program and the embodiments of the computer-readable medium for recording the program, the processing for recording, processing for inquiring the state, processing for responding the state, and processing for inquiring abnormal state restoration are executed in a program. The program is stored in a recording apparatus, and read in a central processing unit (CPU) from a recording apparatus. Operations in the flow charts of FIGS. 4-7 are executed by the central processing unit.

The recording apparatus and the central processing unit are not illustrated.

Each of the embodiments has been explained based on the computers connected to the network. This is because a performance of the computer can be utilized effectively in the above embodiments in considering that the performance of the computers has been improved and a price of the computers has been lowered recently. However, the electronic apparatus can be any apparatus, e.g., facsimile, printer, mobile terminal, etc., which can be mutually connected electronically. Further, the recording unit, state inquiring unit, state responding unit, and abnormal state restoration inquiring unit can be configured as a hardware, software, firmware, or a combination of them.

As stated, according to this invention, the electronic apparatus can detect the abnormal state in the monitored electronic apparatus.

The state information can include the operation state in the monitored electronic apparatus.

Since the state information includes the operation state in the monitored electronic apparatus, the state inquiring unit can judge the operation state in the monitored electronic apparatus.

Further, when the monitored electronic apparatus which was judged to be in the abnormal state based on the state information is restored, the state information is updated. Accordingly, the operation state in the monitored electronic apparatus can be stored in the state information.

Further, by inquiring of the plurality of monitored electronic apparatuses, a processing speed for detecting the abnormal state can be improved compared with a processing speed in inquiring of a single monitored electronic apparatus.

Further, the state inquiring unit which has received the response sends an instruction for starting detection of the abnormal state to the electronic apparatus which has sent the response. Accordingly, this triggers a processing for detecting the abnormal state in another electronic apparatus one after another.

The state inquiring unit of the electronic apparatus which has received the instruction for starting the detection of the abnormal state starts a processing for detecting the abnormal state in the other electronic apparatus. Therefore, the processings for detecting the abnormal state can be performed one after another.

In a method for detecting the abnormal state in the monitored electronic apparatus by the electronic apparatus, the electronic apparatus can detect the abnormal state in the monitored electronic apparatus.

In a program for detecting the abnormal state for executing the processings for detecting the abnormal state in the computer, the processing for detecting the abnormal state in the monitored electronic apparatus by the electronic apparatus can be executed in the computer.

By using a computer-readable recording medium in which the program for detecting the abnormal state for executing the processings for detecting the abnormal state in the computer, the processings for detecting the abnormal state can be executed in the computer by the program which has been read by the computer from the recording medium.

Having thus described several particular embodiments of the invention, various alterations, modifications, and improvements will readily occur to those skilled in the art. Such alterations, modifications, and improvements are intended to be part of this disclosure, and are intended to be within the spirit and scope of the invention. Accordingly, the foregoing description is by way of example only and is limited only as defined in the following claims and the equivalents thereto.

What is claimed is:

1. An electronic apparatus for detecting an abnormal state comprising:
a recording unit for recording monitored object identification information for identifying a monitored electronic apparatus which is one of a plurality of electronic apparatuses for detecting the abnormal state and state information;
a state inquiring unit for sending the state information recorded by the recording unit to the monitored electronic apparatus identified based on the monitored object identification information recorded by the recording unit, inquiring state information of the monitored electronic apparatus to detect an abnormal state in the monitored electronic apparatus, receiving a response from the monitored electronic apparatus, and updating the state information recorded in the recording unit based on the response received; and
a state responding unit for receiving the state information of the monitored electronic apparatus sent by the monitored electronic apparatus, responding the state information recorded in the recording unit to an inquiry about the state information from the monitored electronic apparatus, and recording the state information of the monitored electronic apparatus received in the recording unit.

2. The electronic apparatus for detecting the abnormal state according to claim 1, wherein the recording unit records an operation state in the monitored electronic apparatus in the state information.

3. The electronic apparatus for detecting the abnormal state according to claim 1, wherein the recording unit records an operation state in the monitored electronic apparatus in the state information, wherein the state inquiring unit judges if the monitored electronic apparatus is operating based on the state information recorded in the recording unit before sending the state information recorded in the recording unit.

4. The electronic apparatus for detecting the abnormal state according to claim 1, wherein the recording unit records an operation state in the monitored electronic apparatus in the state information, further comprising an abnormal state restoration inquiring unit for inquiring the state information of the monitored electronic apparatus which is judged to be in an abnormal state based on the state information recorded in the recording unit, receiving a response from the monitored electronic apparatus, and updating the state information in the recording unit based on the response received.

5. The electronic apparatus for detecting the abnormal state according to claim 1, wherein the recording unit records monitored object identification information for identifying a plurality of monitored electronic apparatuses which are objects to be monitored in the monitored object identification information, wherein the state inquiring unit inquires of the plurality of monitored electronic apparatuses identified based on the monitored object identification information for identifying the plurality of monitored electronic apparatuses recorded in the recording unit.

6. The electronic apparatus for detecting the abnormal state according to claim 1, wherein the state inquiring unit sends an instruction for starting detection of an abnormal state in another electronic apparatus to the monitored electronic apparatus from which the response is received.

7. The electronic apparatus for detecting the abnormal state according to claim 6, wherein when the state responding unit receives the instruction for starting the detection of the abnormal state from the monitored electronic apparatus, the state responding unit instructs the state inquiring unit to start a processing for detecting the abnormal state in the other electronic apparatus by sending the instruction received to the state inquiring unit.

8. A method for detecting an abnormal state comprising:
recording monitored object identification information for identifying a monitored electronic apparatus which is one of a plurality of electronic apparatuses for detecting the abnormal state and state information;
sending the state information recorded to the monitored electronic apparatus identified based on the monitored object identification information recorded, inquiring state information of the monitored electronic apparatus to detect an abnormal state in the monitored electronic apparatus, receiving a response from the monitored electronic apparatus, and updating the state information based on the response received; and
receiving the state information of the monitored electronic apparatus sent by the monitored electronic apparatus, responding the state information recorded to an inquiry about the state information from the monitored electronic apparatus, and recording the state information of the monitored electronic apparatus received.

9. A computer program for detecting an abnormal state comprising:
a code segment for recording monitored object identification information for identifying a monitored electronic apparatus which is one of a plurality of electronic apparatuses for detecting the abnormal state and state information;
a code segment for sending the state information recorded to the monitored electronic apparatus identified based on the monitored object identification information recorded, inquiring state information of the monitored electronic apparatus to detect an abnormal state in the monitored electronic apparatus, receiving a response from the monitored electronic apparatus, and updating the state information based on the response received; and
a code segment for receiving the state information of the monitored electronic apparatus sent by the monitored electronic apparatus, responding the state information recorded to an inquiry about the state information from the monitored electronic apparatus, and recording the state information of the monitored electronic apparatus received.

10. A computer-readable storage medium having a computer program for detecting an abnormal state recorded thereon, the computer program comprising:
a code segment for recording monitored object identification information for identifying a monitored electronic apparatus which is one of a plurality of electronic apparatuses for detecting the abnormal state and state information;
a code segment for sending the state information recorded to the monitored electronic apparatus identified based on the monitored object identification information recorded, inquiring state information of the monitored electronic apparatus to detect an abnormal state in the monitored electronic apparatus, and receiving a response from the monitored electronic apparatus, and updating the state information based on the response received; and
a code segment for receiving the state information of the monitored electronic apparatus sent by the monitored electronic apparatus, responding the state information recorded to an inquiry about the state information from the monitored electronic apparatus, and recording the state information of the monitored electronic apparatus received.

11. A system for detecting an abnormal state comprising a plurality of electronic apparatuses for detecting the abnormal state, wherein each of the plurality of electronic apparatuses includes a recording unit, a state inquiring unit and a state responding unit, wherein the recording unit records monitored object identification information for identifying a monitored electronic apparatus which is one of the plurality of electronic apparatuses for detecting the abnormal state and state information, wherein the state inquiring unit identifies the monitored electronic apparatus based on the monitored object identification information recorded by the recording unit, sends the state information recorded by the recording unit to the monitored electronic apparatus identified, and inquires state information of the monitored electronic apparatus to detect an abnormal state in the monitored electronic apparatus, wherein a state responding unit of the monitored electronic apparatus inquired sends the state information recorded in a recording unit of the monitored electronic apparatus to the state inquiring unit which has inquired, and records the state information received in the recording unit of the monitored electronic apparatus, wherein the state inquiring unit inquired further receives the state information of the monitored electronic apparatus sent by the monitored electronic apparatus, and records the state information received in the recording unit of the own electronic apparatus for detecting the abnormal state.
